(19) United States
(12) Patent Application Publication
(10) Pub. No.: US 2016/0379643 A1
(43) Pub. Date: Dec. 29, 2016

(54) Group Status Determining Device and Group Status Determining Method

(71) Applicants: TOYOTA INFOTECHNOLOGY CENTER CO., LTD., Tokyo (JP); Inter-University Research Institute Corporation Research Organization of Information and Systems, Tokyo (JP)

(72) Inventors: Junichi Ito, Nagoya-shi (JP); Atsushi Ikeno, Kyoto-shi (JP); Kenro Aihara, Tokyo (JP); Susumu Kono, Tokyo (JP)

(21) Appl. No.: 15/190,193

(22) Filed: Jun. 23, 2016

(30) Foreign Application Priority Data
Jun. 23, 2015 (JP) 2015-125632

(51) Int. Cl. G10L 17/02; G10L 17/22; G10L 25/54; G10L 25/72; G10L 15/18

(52) U.S. Cl. CPC G10L 17/02; G10L 25/72; G10L 15/1822; G10L 25/54; G10L 17/22; G10L 21/028

(57) ABSTRACT

A group status determining device determining a status of a group made up of a plurality of speakers engaged in a conversation includes: a storage that stores determination criteria, based on conversation situational data with respect to a plurality of group types; and a processor configured to operate as: an acquisition module that acquires conversation situational data, which is data regarding a series of groups of utterances made by a plurality of speakers and estimated to be on a same conversation theme; and a determination module that acquires a type of the group made up of the plurality of speakers, based on the conversation situational data and the determination criteria as a group status of the group made up of the plurality of speakers.

### CROSS-REFERENCE TO RELATED APPLICATION

This application claims the benefit of Japanese Patent Application No. 2015-125632, filed on Jun. 23, 2015, which is hereby incorporated by reference herein in its entirety.

### BACKGROUND OF THE INVENTION

Field of the Invention

The present invention relates to a technique for determining a status of a group made up of a plurality of speakers engaged in a conversation.

Description of the Related Art

In recent years, research and development of techniques for performing various types of interventions such as making proposals and providing support from computers to humans are underway. For example, Japanese Patent Application Laid-open No. 2009-36998 and Japanese Patent Application Laid-open No. 2009-36999 disclose selecting a keyword being uttered by a user from conversation data to comprehend contents of the utterance and responding in accordance with the utterance contents. Other systems are known which provide information in accordance with a status or preferences of an individual.

The methods described in Japanese Patent Application Laid-open No. 2009-36998 and Japanese Patent Application Laid-open No. 2009-36999 assume a dialogue between one speaker and a computer and do not assume intervening in a conversation carried out by a group made up of a plurality of speakers.

A conversation carried out by a group may include a conversation for decision making such as deciding on a destination. Even when intervening in such a conversation with a focus on statuses or preferences of individuals, it is unclear as to whose opinion should be valued in the event that opinions of members differ from one another. When determining contents of an intervention based solely on utterance contents, opinions of members who have presented arguments with more explicit and specific contents tend to be prioritized. However, this means that members unable to voice explicit opinions will feel increasingly dissatisfied.

### SUMMARY OF THE INVENTION

In consideration of problems such as those described above, an object of the present invention is to determine a status of a group made up of a plurality of speakers engaged in a conversation in order to enable an appropriate intervention to be performed on the group. An object of the present invention is to perform an appropriate intervention in accordance with a group status determined in this manner.

In order to achieve the object described above, a first aspect of the present invention is a group status determining device determining a status of a group made up of a plurality of speakers engaged in a conversation, the group status determining device including: an acquiring unit that acquires conversation situational data, which is data regarding a series of groups of utterances made by a plurality of speakers and estimated to be on a same conversation theme; a storage that stores determination criteria, based on the conversation situational data, with respect to a plurality of group types; and a determining unit that acquires a type of the group made up of the plurality of speakers, based on the conversation situational data and the determination criteria, as a group status of the group made up of the plurality of speakers.

A group type is a classification indicating a relationship among members that make up a group. Although group types may be arbitrarily defined, conceivable examples include “a group with a flat relationship and high intimacy, in which members are able to mutually voice their opinions frankly”, “a group with a hierarchical relationship but high intimacy, in which a specific member leads decision making of the group”, and “a group with a hierarchical relationship and low intimacy, in which a specific member leads decision making of the group”. The storage stores determination criteria for determining, based on conversation situational data, which group type a given group corresponds to.

In this case, as data regarding a series of groups of utterances, conversation situational data can include, for example, a speaker of each utterance, a correspondence relationship between utterances, semantics and an intention of each utterance, emotions of a speaker during each utterance, an utterance frequency of each speaker, an utterance feature value of each speaker, and a relationship between the speakers.

For example, when the conversation situational data includes an utterance feature value of each speaker in a series of groups of utterances, criteria for determining a group type based on utterance feature values can be adopted as the determination criteria. In this case, the determining unit can determine which group type a given group corresponds to, based on utterance feature values contained in conversation situational data and determination criteria stored in the storage.

In addition, when the conversation situational data further includes a relationship between utterances and utterance intentions in the series of groups of utterances, the determining unit may favorably estimate an opinion exchange situation in the group based on the information and determine a group type also in consideration of opinion exchange situation. In this case, the determining unit may determine at least any of liveliness of exchange of opinions in the group, a ratio of agreements against disagreements to a proposal, and presence or absence of an influencer in decision making as the opinion exchange situation.

In the present invention, favorably, the determining unit further determines a relationship among a plurality of speakers included in a group as a group status based on a relationship between utterances and utterance intentions. Examples of relationships among speakers include an influencer and a follower in decision making, a superior and a subordinate, a parent and a child, and friends. The relationship among speakers can be considered as being expressive of roles performed by the respective speakers in the group.

The relationship among speakers can be determined based on wording used in the utterances. For example, when there is a person using commanding language and a person responding thereto in honorifics in the group, the speakers can be determined as a superior and a subordinate. In addition, speakers respectively using informal language can be determined as speakers having a relationship of equals. Furthermore, when one person is using child language and another is using language that is typically used to address a child, the speakers can be determined as an adult and a child or a parent and a child.

In the present invention, the determining unit can acquire a status change of a group as a group status. An example of a status change of a group includes an occurrence of stagnation of utterances. An occurrence of stagnation of utterances can be determined based on utterance feature values. Moreover, stagnation of utterances includes both stagnation of utterances by a specific speaker and stagnation of utterances by a group as a whole.

With the group status determining device according to the present aspect, what kind of status a group made up of a plurality of speakers is in can be optimally determined.

A second aspect of the present invention is a support device which intervenes in and supports a conversation held by a group made up of a plurality of speakers. The support device according to the present aspect includes: the group status determining device described above; an intervention policy storing unit which stores a correspondence between group statuses and intervention policies; and an intervening unit which determines contents of an intervention in a conversation by the group based on an intervention policy corresponding to a group status obtained by the group status determining device and which performs an intervention in the conversation.

In the present aspect, favorably, the intervention policies define which member in a group is to be preferentially supported for each group type. In this case, a member in a group can be specified based on a relationship or roles of members in the group. For example, the intervention policies can define preferentially supporting an influencer in a group or preferentially supporting a follower in the group. In addition, a member to be preferentially supported can be specified as a member who has experienced a given status change. For example, the intervention policy can define preferentially supporting a member whose utterance frequency has declined.

With the support device according to the present aspect, optimal support can be provided in accordance with a group status.

Moreover, the present invention can be considered as a group status determining device or a support device including at least a part of the unit described above. In addition, the present invention can also be considered as a conversation situation analyzing method or a supporting method which executes at least a part of the processes performed by the unit described above. Furthermore, the present invention can also be considered as a computer program that causes these methods to be executed by a computer or a computer-readable storage unit that non-transitorily stores the computer program. The respective units and processes described above can be combined with one another in any way possible to constitute the present invention.

According to the present invention, what kind of status a group made up of a plurality of speakers is in can be optimally determined. In addition, according to the present invention, appropriate support can be provided based on a group status optimally determined in this manner.

### BRIEF DESCRIPTION OF THE DRAWINGS

FIG. 1 is a diagram showing a configuration example of a conversation intervention support system according to a first embodiment;

FIG. 2 is a diagram showing an example of functional blocks of the conversation intervention support system according to the first embodiment;

FIG. 3 is a flow chart showing an example of an overall flow of processes in a conversation intervention support method performed by the conversation intervention support system according to the first embodiment;

FIG. 4 is a flow chart showing an example of a flow of a conversation situation analyzing process (S303) in a conversation intervention support method;

FIG. 5 is a diagram showing examples of utterances separated for each speaker and for each utterance section;

FIG. 6 is a diagram showing examples of a category, a location as a conversation topic, and an intention extracted for each utterance;

FIG. 7 is a diagram showing examples of a series of groups of utterances having a same conversation theme;

FIG. 8 is a diagram showing examples of conversation situational data;

FIG. 9A is a diagram explaining a correspondence relationship between utterances, a conversation theme of each utterance, utterance intentions, and emotions of speakers contained in conversation situational data, and FIG. 9B is a diagram explaining examples of an utterance occurrence situation between speakers in a conversation and a relationship between the speakers;

FIG. 10 is a flow chart showing an example of a flow of a group status determining process (S304) in a conversation intervention support method;

FIG. 11A is a diagram showing examples of group types and FIG. 11B is a diagram showing examples of estimation conditions of group types;

FIG. 12 is a flow chart showing an example of a flow of an intervention content determining process (S305) in a conversation intervention support method; and

FIG. 13A is a diagram explaining intervention policies in accordance with group types and FIG. 13B is a diagram explaining examples of intervention methods in accordance with status changes of a group.

### DESCRIPTION OF THE EMBODIMENTS

### First Embodiment

<System Configuration>

The present embodiment is a conversation intervention support system which intervenes in a conversation held by a plurality of persons in a vehicle to provide information or support for decision making. The present embodiment is configured so that an appropriate intervention can also be performed in a conversation held by a plurality of persons and, in particular, a conversation held by three or more persons.

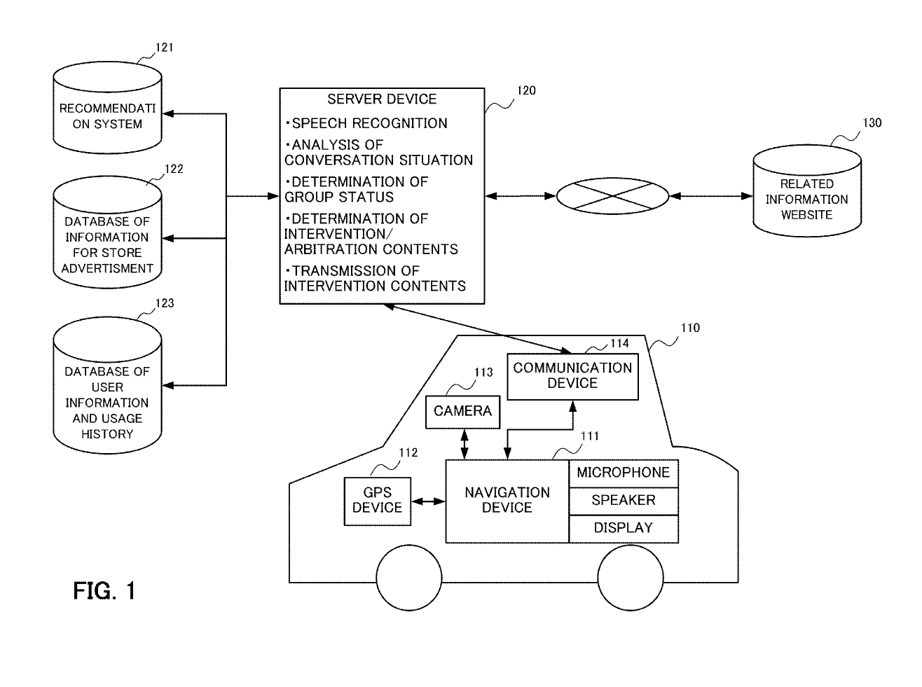

FIG. 1 is a diagram showing a configuration example of a conversation intervention support system according to the present embodiment. Conversational speech of passengers acquired by a navigation device 111 via a microphone is sent to a server device 120 via a communication device 114. The server device 120 analyzes the conversational speech transmitted from a vehicle 110 and performs intervention in the form of providing appropriate information, supporting decision making, or the like in accordance with the situation. The server device 120 analyzes the conversational speech to determine under what kind of policy an intervention is to be performed, and acquires information consistent with the policy from a recommendation system 121, a database 122 of information for store advertisement, and a related information website 130. The server device 120 transmits an intervention instruction to the vehicle 110, and the vehicle 110 performs audio reproduction or displays a text or an image through a speaker or a display of the navigation device 111. In addition, the vehicle 110 is provided with a GPS device 112 which acquires a current position and a camera 113 which photographs the face or the body of a passenger (speaker).

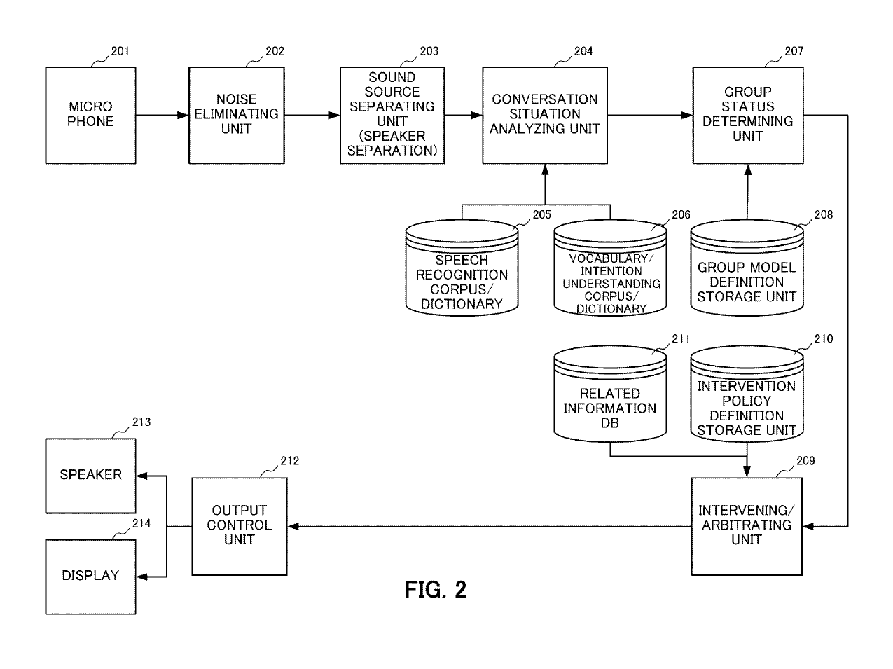

FIG. 2 is a functional block diagram of the conversation intervention support system according to the present embodiment. The conversation intervention support system includes a microphone (a speech input unit) 201, a noise eliminating unit 202, a sound source separating unit (a speaker separating unit) 203, a conversation situation analyzing unit 204, a speech recognition corpus/dictionary 205, a vocabulary/intention understanding corpus/dictionary 206, a group status determining unit 207, a group model definition storage unit 208, an intervening/arbitrating unit 209, an intervention policy definition storage unit 210, a related information DB 211, an output control unit 212, a speaker (a speech output unit) 213, and a display (an image displaying unit) 214. Details of processes performed by the respective functional units will be hereinafter described together with the flow charts.

In the present embodiment, among the respective functions shown in FIG. 2, speech input by the microphone 201 and output of intervention contents by the output control unit 212, the speaker 213, and the display 214 are to be performed in the vehicle 110. The other functions are configured to be performed by the server device 120. However, how the functions are shared between the vehicle 110 and the server device 120 is not particularly limited. For example, noise elimination and sound source separation, and even a speech recognition process may be performed in the vehicle 110. In addition, the server device 120 may perform processes up to determination of an intervention policy and the vehicle 110 may determine what kind of information is to be provided in accordance with the determined intervention policy. Furthermore, all of the functions may be realized inside the vehicle 110.

Moreover, the navigation device 111 and the server device 120 are both computers including a processing device such as a CPU, a storage device such as a RAM and a ROM, an input device, an output device, a communication interface, and the like, and realize the respective functions described above as the processing device executes a program stored in the storage device. However, a part of or all of the functions described above may be realized by dedicated hardware. In addition, the server device 120 need not necessarily be one device and may be constituted by a plurality of devices (computers) connected to one another via a communication line, in which case the functions are to be shared among the respective devices. <Overall Process>

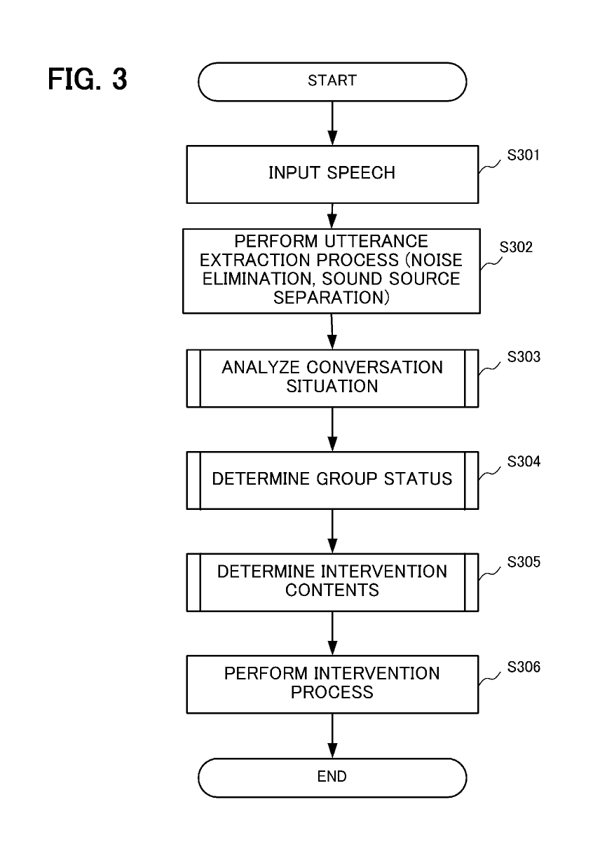

FIG. 3 is a flow chart showing an overall flow of the conversation intervention support method performed by the conversation intervention support system according to the present embodiment. The conversation intervention support method as a whole will now be described with reference to FIG. 3.

In step S301, the navigation device 111 acquires conversational speech by a plurality of passengers in the vehicle 110 via the microphone 201. In the present embodiment, since subsequent processes on the acquired speech are to be performed by the server device 120, the navigation device 111 transmits the acquired conversational speech to the server device 120 via the communication device 114. Moreover, although the number and arrangement of microphones used are not particularly limited, a plurality of microphones or microphone arrays are favorably used.

In step S302, the server device 120 extracts respective utterances of each speaker from the conversational speech using the noise eliminating unit 202 and the sound source separating unit 203. Moreover, an “utterance” refers to the generation of language in the form of speech as well as speech generated as a result of such generation of language. The process performed at this point includes noise elimination by the noise eliminating unit 202 and sound source separation (speaker separation) by the sound source separating unit 203. The noise eliminating unit 202 specifies and eliminates noise based on, for example, a difference between speech obtained from a microphone arranged near a noise generation source and speech obtained from another microphone. In addition, the noise eliminating unit 202 eliminates noise using a correlation in speech input to a plurality of microphones. The sound source separating unit 203 detects a direction and a distance of each speaker with respect to a microphone based on a time difference between inputs of speech to the plurality of microphones in order to specify a speaker.

In step S303, the conversation situation analyzing unit 204 analyzes a situation of a conversation held by a plurality of persons. In order to analyze a situation of a conversation held by a plurality of persons and, in particular, three or more persons, for example, whether or not there is a correlation among utterances by the respective speakers and, in a case where a correlation exists, what kind of relationship exists among the utterances must be recognized. In consideration thereof, the conversation situation analyzing unit 204 extracts a group of utterances related to a same conversation theme as a series of groups of utterances, and further comprehends a relationship among utterances in the group of utterances to analyze a situation of the conversation and a relationship among the speakers in consideration with the relationship among the utterances. Specific contents of the process performed by the conversation situation analyzing unit 204 will be described later.

In step S304, based on conversation situational data provided by the conversation situation analyzing unit 204, the group status determining unit 207 determines a group type of a group of speakers participating in a same conversation or a status of the group of speakers. Conceivable examples of groups include “a group with a flat relationship and high intimacy, in which members are able to mutually voice their opinions frankly”, “a group with a hierarchical relationship but high intimacy, in which a specific member leads decision making of the group”, and “a group with a hierarchical relationship and low intimacy, in which a specific member leads decision making of the group”. In addition, conceivable examples of status changes of a group include a decline in an utterance frequency of a specific member, a decline in utterance frequency of an entire group, a change in emotion of a specific member, and a change in influencers of a group. Specific contents of the process performed by the group status determining unit 207 will be described later.

In step S305, the intervening/arbitrating unit 209 determines an intervention policy in accordance with a group status provided by the group status determining unit 207 and determines a specific timing and contents of the intervention based on the intervention policy and contents of a current conversation. For example, in a case of a group with a flat relationship and high intimacy, in which members are able to mutually voice their opinions frankly, an intervention policy may conceivably be adopted in which detailed reference information is more or less equally presented to everyone to facilitate a lively discussion. In addition, for example, when an utterance frequency of a specific speaker or the entire group has declined, an intervention policy of providing guidance so as to stimulate the conversation may conceivably be adopted. Once an intervention policy is determined, the intervening/arbitrating unit 209 acquires information to be presented in accordance with a current conversation topic from the recommendation system 121, the database 122 of information for store advertisement, or the related information website 130 and issues an intervention instruction. Specific contents of the process performed by the intervening/arbitrating unit 209 will be described later.

In step S306, the output control unit 212 generates synthesized speech or a text to be output in accordance with the intervention instruction output from the intervening/arbitrating unit 209 and reproduces the synthesized speech or the text using the speaker 213 or the display 214.

An intervention in a conversation held by a plurality of speakers in the vehicle 110 may be performed as described above. Moreover, the processes presented in the flow chart shown in FIG. 3 are repetitively executed. The conversation intervention support system acquires conversational speech whenever necessary to continuously monitor a conversation situation, a relationship among speakers, and a group status, and performs an intervention when it is determined that such intervention is necessary. <Conversation Situation Analyzing Process>

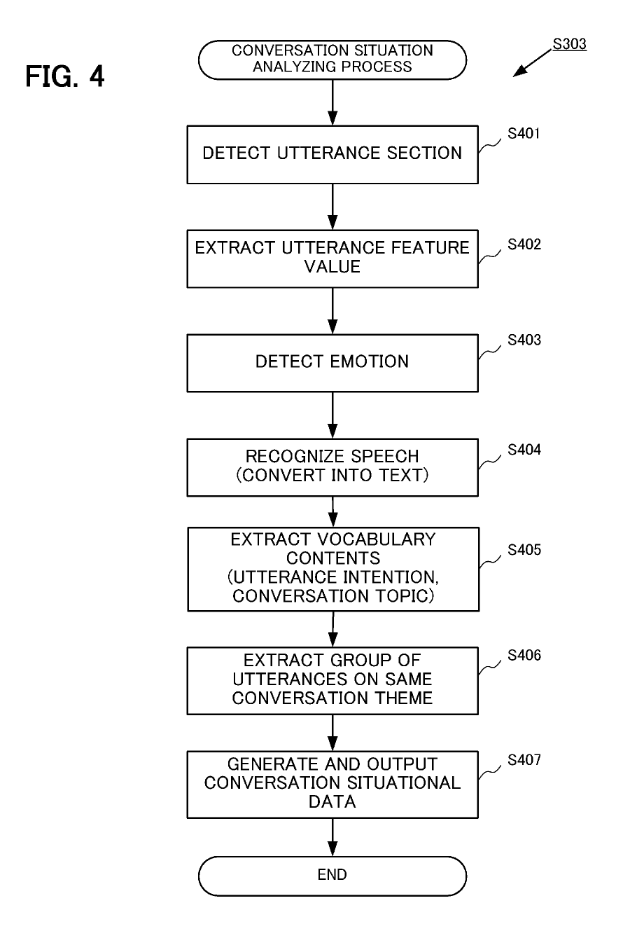

Next, details of the conversation situation analyzing process in step S303 will be described. FIG. 4 is a flow chart showing a flow of the conversation situation analyzing process. Moreover, the process of the flow chart shown in FIG. 4 need not necessarily be performed in the illustrated sequence and a part of the process may be omitted.

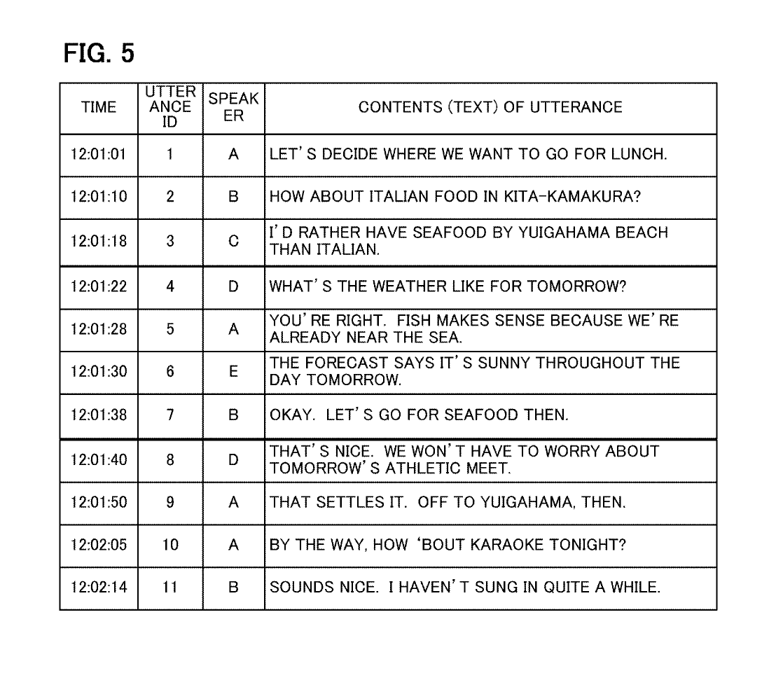

In step S401, the conversation situation analyzing unit 204 detects utterance sections from speech data obtained by sound source separation and adds a section ID and a time stamp to each utterance section. Moreover, an utterance section is a single continuous section in which speech is being uttered. An utterance section is assumed to end before, for example, an occurrence of a non-utterance of 1500 milliseconds or more. Due to this process, conversational speech can be separated into a plurality of pieces of speech data for each speaker and for each utterance section. Hereinafter, speech of an utterance in one utterance section may also be simply referred to as an utterance. FIG. 5 shows respective utterances separated in step S401.

In step S402, the conversation situation analyzing unit 204 calculates utterance feature values (speech feature values) for each utterance. Examples of utterance feature values include a power level of voice, a pitch, a tone, a duration, an utterance speed (an average mora length). A power level of voice indicates a sound pressure level of an utterance. A tone indicates a height of a sound or a sound itself. The height of sound is specified by the number of vibrations (frequency) of sonic waves per second. A pitch indicates a height of perceived sound and is specified by a physical height (fundamental frequency) of a sound. An average mora length is calculated as a length (period of time) of an utterance per mora. A mora refers to the number of beats. In this case, with respect to a power level of voice, a pitch, a tone, and an utterance speed, favorably, an average value, a maximum value, a minimum value, a variation width, a standard deviation, or the like in an utterance section is obtained. While the utterance feature values described above are to be calculated in the present embodiment, all of the utterance feature values exemplified above need not be calculated and utterance feature values other than those exemplified above may be calculated.

In step S403, the conversation situation analyzing unit 204 obtains an emotion of a speaker for each utterance from a change in utterance feature values. Examples of emotions to be obtained include satisfaction, dissatisfaction, excitement, anger, sadness, anticipation, relief, and anxiety. An emotion can be obtained based on, for example, a change in a power level, a pitch, or a tone of an utterance from a normal status thereof. Utterance feature values during a normal status of each speaker may be derived from previously obtained utterance feature values or information stored in a database 123 of user information and usage history may be used. Moreover, an emotion of a speaker need not be determined based solely on utterances (speech data). An emotion of a speaker can also be obtained from contents (a text) of an utterance. Alternatively, for example, a facial feature value can be calculated from a facial image of a speaker taken by the camera 113, in which case an emotion of the speaker can be obtained based on a change in the facial feature value.

In step S404, on each utterance, the conversation situation analyzing unit 204 performs a speech recognition process using the speech recognition corpus/dictionary 205 to convert utterance contents into a text. Known techniques may be applied for the speech recognition process. The utterance contents (the text) shown in FIG. 5 are obtained by the process performed in step S404.

In step S405, the conversation situation analyzing unit 204 estimates an intention and a conversation topic of each utterance from the contents (the text) of the utterance by referring to the vocabulary/intention understanding corpus/dictionary 206. Examples of an utterance intention include starting a conversation, making a proposal, agreeing or disagreeing with a proposal, and consolidating opinions. Examples of a conversation topic of an utterance include a category of the utterance, a location, and a matter. Examples of a category of an utterance include drinking and eating, travel, music, and weather. Examples of a location brought up as a conversation topic include a place name, a landmark, a store name, and a facility name. The vocabulary/intention understanding corpus/dictionary 206 includes dictionaries of vocabularies respectively used in cases of “starting a conversation, making a proposal, asking a question, voicing agreement, voicing disagreement, consolidating matters”, and the like, dictionaries of vocabularies related to “drinking and eating, travel, music, weather, and the like” for specifying a category of an utterance, and dictionaries of vocabularies related to “a place name, a landmark, a store name, a facility name, and the like” for specifying a location brought up as a conversation topic. Moreover, when estimating the utterance intention, an emotion of a speaker is favorably taken into consideration in addition to the text of the utterance. For example, when the utterance contents (the text) indicates consent to a proposal, the utterance intention can be estimated in greater detail by taking the emotion of the speaker into consideration such as a case of joyful consent and a case of grudging consent.

As a result of the process of step 5405, an intention of a speaker such as “what the speaker wants to do” and a category that is being discussed as a conversation topic can be estimated for each utterance. For example, with respect to a text reading “How about Italian food in Kita-Kamakura?” designated by utterance ID2 in FIG. 5, by collating the text with the dictionaries, a category can be estimated as “drinking and eating (cuisine)” from the word “Italian food”, a location as a conversation topic can be estimated as “Kamakura” from the word “Kita-Kamakura”, and an utterance intention can be estimated as “a proposal” from the word “how about”.

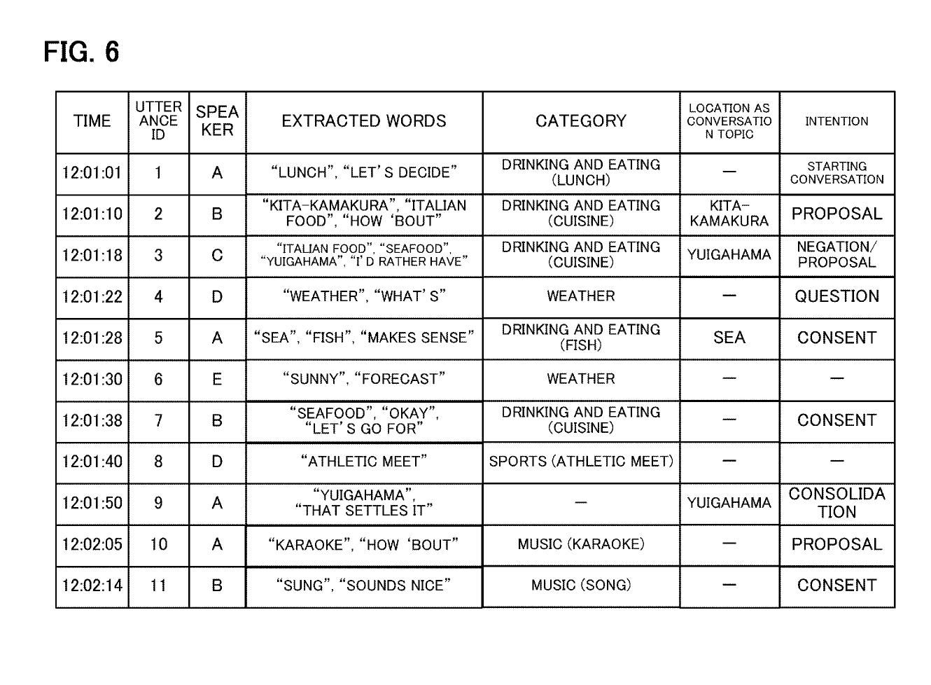

FIG. 6 shows extraction results of a category being brought up as a conversation topic, a location being brought up as a conversation topic, and an utterance intention with respect to the respective utterances shown in FIG. 5. In the present embodiment, for example, an “utterance n(S)” for which an intention and the like are estimated is expressed by the following equation.

Utterance n(S)=(Cₙ, Pₙ, Iₙ)

In this case, n denotes an utterance ID (1 through k) which is assumed to be assigned in an order of occurrence of utterances. S denotes a speaker (A, B, C, . . . ), and Cₙ, Pₙ, and Iₙ respectively denote an estimated category of the utterance, an estimated location being brought up as a conversation topic, and an estimated utterance intention.

For example, when a collation of an utterance 1 by a speaker A with the vocabulary/intention understanding corpus/dictionary 206 results in matches of “C₁: drinking and eating”, “P₁: Kamakura”, and “I₁: starting a conversation”, the utterance 1 is expressed as follows.
Utterance 1 (A)=(“drinking and eating,”, “Kamakura”, and “starting a conversation”)

Moreover, with respect to each utterance, information such as a category being brought up as a conversation topic, a location as a conversation topic, and an utterance intention is favorably obtained by also taking information other than contents (a text) of the utterance into consideration. In particular, the utterance intention is favorably obtained by also taking the emotion of the speaker obtained from utterance feature values into consideration. Even when the utterance contents indicate an agreement to a proposal, utterance feature values enable a distinction to be made between a joyful consent and a grudging consent. Furthermore, depending on the utterance, such information cannot be extracted from the utterance contents (the text). In such a case, the conversation situation analyzing unit 204 may estimate the utterance intention by considering extraction results of intentions and utterance contents (texts) previously and subsequently occurring along a time series.

In step S406, the conversation situation analyzing unit 204 extracts utterances estimated as being made on a same theme in consideration of the category of each utterance and a time-sequential result of utterances obtained in step S405 and specifies a group of utterances obtained as a result of the extraction as a group of a series of utterances included in the conversation. According to this process, utterances included in one conversation from the start to end of the conversation can be specified.

In identity determination of a conversation theme, similarities of categories and locations as conversation topics of utterances are taken into consideration. For example, with respect to utterance ID5, while a category thereof is determined as “drinking and eating” from an extracted word “fish” and a location as the conversation topic is determined as “sea” from an extracted word “sea”, since both are concerned with the category “drinking and eating”, the utterance can be determined to have a same conversation theme. In addition, utterances may sometimes include a word (“let's decide”) that enables a determination of “starting a conversation” to be made as in the case of utterance ID1 or a word (“that settles it”) that enables a determination of “consolidating”) to be made as in the case of utterance ID9, and each of the utterances can be estimated to be an utterance made at the start or the end of a conversation on a same theme. Furthermore, in consideration of a temporal relationship among utterances, different conversation themes may be determined when a time interval between utterances is too long even when the category or the location as the conversation topic of the utterances is the same. Moreover, there may be utterances that do not include words from which an intention or a category can be extracted. In such a case, in consideration of a time-sequential flow of utterances, utterances by a same speaker occurring between the start and the end of a same conversation may be assumed as being included in a same conversation.

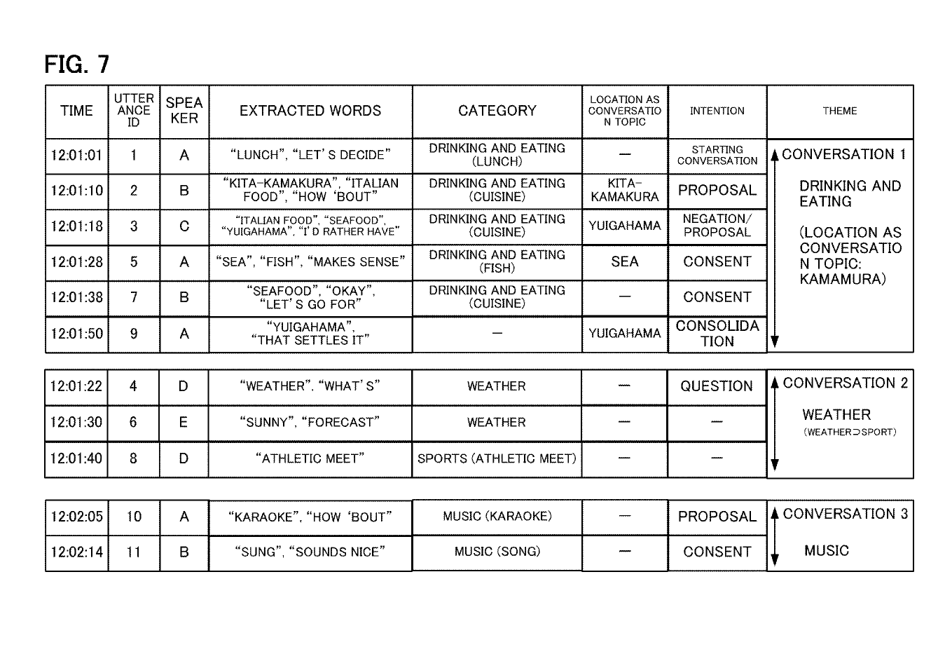

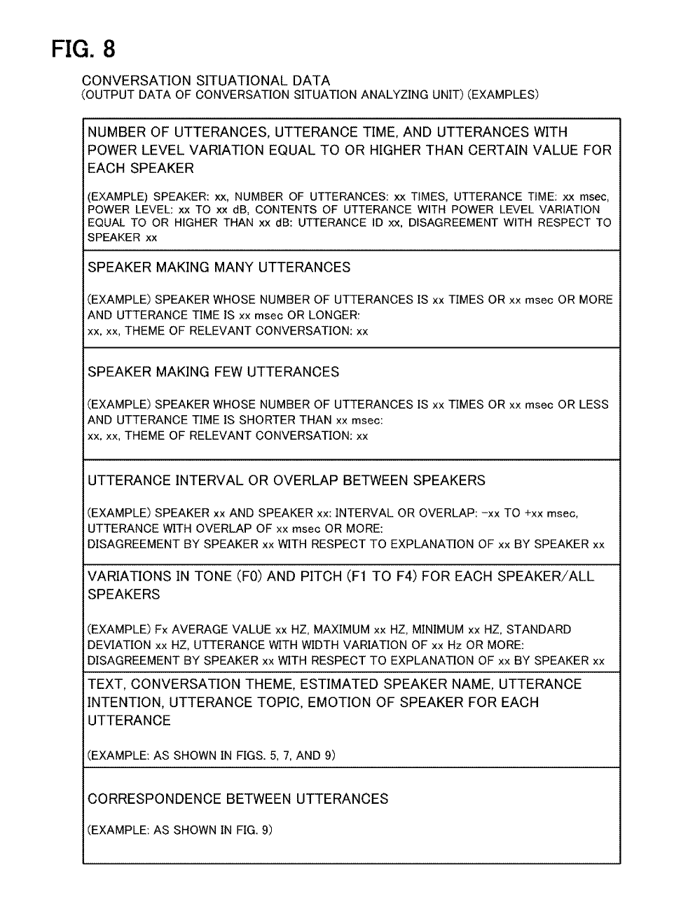

FIG. 7 is a diagram showing a result of specifying a series of groups of utterances based on a category, a location as a conversation topic, and an utterance intention of each utterance shown in FIG. 6. In this case, three conversations have been extracted. Conversation 1 is a conversation related to “drinking and eating (lunch)”, “drinking and eating (cuisine)”, and “Kamakura” and includes utterances ID1, ID2, ID3, ID5, ID7, and ID9. Conversation 2 is a conversation related to “weather” and “sports (athletic meet) ” and includes utterances ID4, ID6, and ID8. Moreover, although “weather” and “sports (athletic meet)” represent different categories, when an utterance related to “sports (athletic meet)” consecutively occurs immediately after an utterance related to “weather”, the utterances are determined to be included in a conversation related to “weather”. Conversation 3 is a conversation related to “music” and includes utterances ID10 and ID11.

While the utterances shown in FIG. 5 are made by a total of five speakers A to E, not everyone participates in a same conversation. In this case, three speakers A to C are engaged in conversation 1 related to drinking and eating while speakers D and E are engaged in conversation 2 related to weather. Since the conversation situation analyzing unit 204 according to the present embodiment focuses on a category, a location (matter) being brought up as a conversation topic, and an utterance intention of each utterance, a group of utterances included in a series of conversations can be appropriately specified even when a plurality of conversations are taking place at the same time.

In the present embodiment, for example, a series of “Conversation m” specified in this manner is expressed by the following equation.

Conversation m (S_{A}, S_{B}, S_{c} . . . )={utterance 1 (S_{A}), utterance 2 (S_{B}), utterance 3 (S_{C}) . . . }=Tₘ {(C_{A}, P_{A}, I_{A}), (C_{B}, P_{B}, I_{B}), (C_{C}, P_{C}, I_{C}) . . . }

In this case, m denotes a conversation ID (1 through k) which is assumed to be assigned in an order of occurrence of conversations. S_{A},S_{B},S_{C} . . . denotes a speaker (A, B, C, . . . ) and Tₘ, Cₙ, Pₙ, and Iₙ respectively denote an estimated conversation theme, an estimated category of an utterance, an estimated location being brought up as a conversation topic, and an estimated utterance intention.

For example, when a group of utterances regarding a theme “drinking and eating” by the speakers A, B, and C is specified as belonging to conversation 1, conversation 1 is expressed as follows.

Conversation 1 (A, B, C)=T_{“drinking and eating”} {“drinking and eating (lunch)”, “Kamakura”, “starting a conversation”), (“drinking and eating (cuisine)”, “Kamakura”, “proposal”), (“drinking and eating (cuisine)”, “na”, “negation/proposal”) . . . }

In step S407, the conversation situation analyzing unit 204 generates and outputs conversation situational data that integrates the analysis results described above. For example, conversation situational data includes information such as that shown in FIG. 8 with respect to utterances in a same conversation during a most recent prescribed period (for example, three minutes). A speaker making many utterances is a speaker for which both the number of utterances in the period and an utterance time are equal to or greater than prescribed values (for example, once and 10 seconds). A speaker making a few utterances is a speaker for which both the number of utterances in the period and an utterance time are below the prescribed values. An average utterance interval or an overlap between speakers is a duration of a silence period between utterance sections or a period during which utterance sections overlap with each other for each pair of speakers. A power level of voice, a tone, a pitch, and an utterance speed are obtained for each speaker and for all speakers. A power level of voice, a tone, a pitch, and an utterance speed are respectively expressed by one of or a plurality of an average value, a maximum value, a minimum value, a variation width, and a standard deviation in the period and, in particular, when a significant variation is measured, the power level of voice, the tone, the pitch, or the utterance speed is shown in association with information such as corresponding utterance contents. In addition, conversation situational data also includes, for each utterance in the period, a text describing utterance contents, a conversation theme, a name of an estimated speaker, an utterance intention, conversation topics (a category, a location, a matter, or the like) of the utterance, and an emotion of the speaker. Furthermore, conversation situational data also includes a correspondence relationship among utterances and a relationship among speakers.

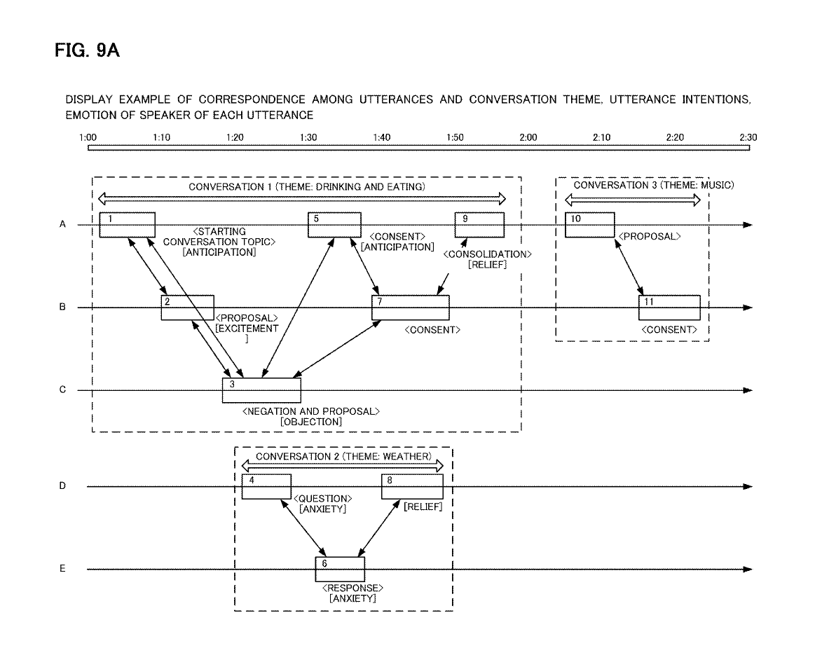

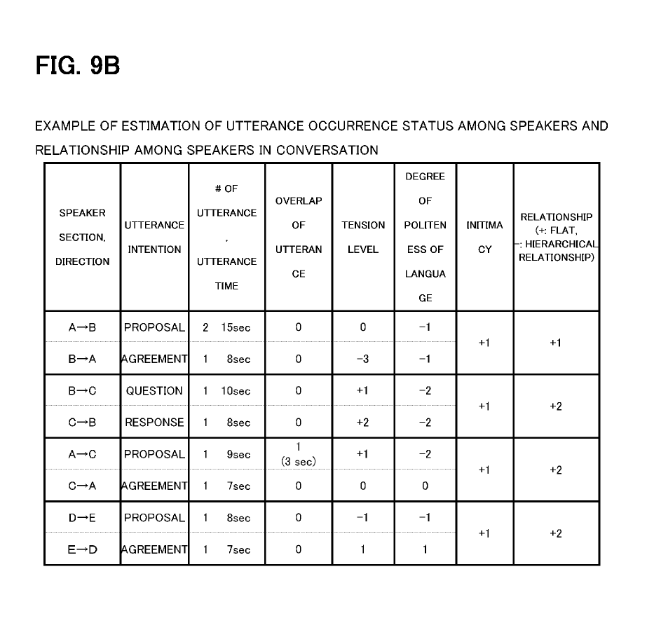

FIG. 9A shows an example displaying a correspondence relationship among utterances, a conversation theme, an utterance intention, and an emotion of a speaker for each utterance. In FIG. 9A, with respect to the speakers A to E, utterance sections are respectively shown in a time series and correspondence relationships among utterances are indicated by arrows. In addition, for each utterance, an utterance intention and an emotion of the speaker are shown (whenever applicable). For example, it is shown that, in response to the speaker A starting a conversation (utterance ID1), the speaker B makes a proposal (utterance ID2), and in response to both utterances, the speaker C voices a disagreement with the proposal and makes a re-proposal (utterance ID3). Moreover, a correspondence relationship among utterances need not be determined based solely on utterances (speech data). For example, a determination may be made as to whether or not a given utterance is made with respect to a specific member based on a line of sight or an orientation of the face or the body of a speaker acquired from the camera 113, and a correspondence relationship among utterances may be obtained as a result of this determination.

FIG. 9B shows what kind of utterances occur at what kind of frequency in the conversation among the speakers A to E, and how a hierarchical relationship and intimacy among the speakers are estimated. Intimacy and a relationship (a flat relationship or a hierarchical relationship) between any two speakers can be obtained based on the utterance intentions, utterance feature values (the number of utterances, utterance times, overlapping of utterances, and tension levels), and wording (degree of politeness) of the utterances between the two speakers. Moreover, although not shown in FIG. 9B, when a hierarchical relationship and the like exists between speakers, which speaker is a superior and which speaker is a subordinate can also be determined.

The conversation situation analyzing unit 204 outputs conversation situational data such as that described above to the group status determining unit 207. Using conversation situational data enables a flow of a conversation to be linked with changes in feature values of each utterance and enables a status of a group engaged in a conversation to be optimally estimated. <Group Status Determining Process>

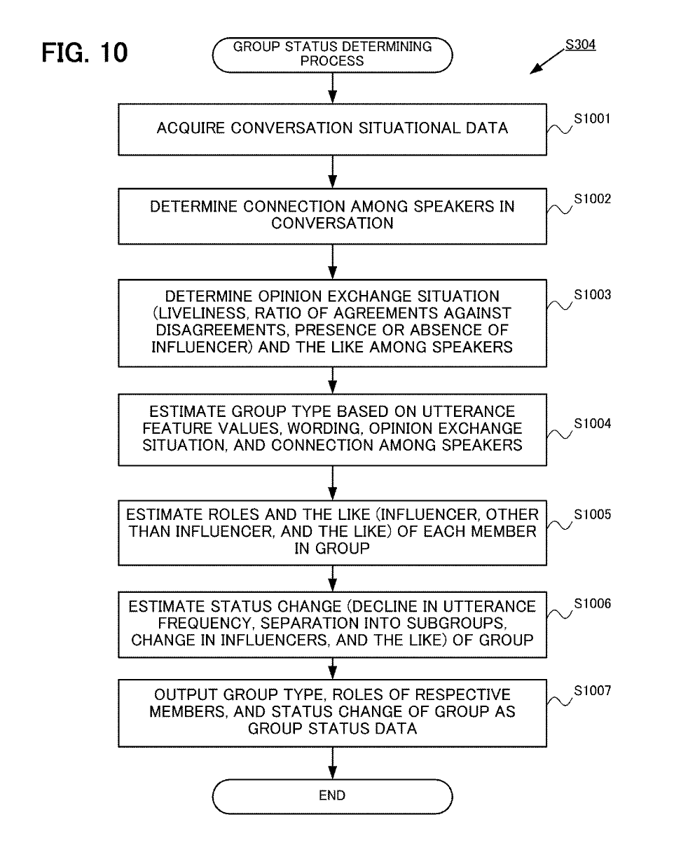

Next, details of the group status determining process in step S304 in FIG. 3 will be described. FIG. 10 is a flow chart showing a flow of the group status determining process.

In step S1001, the group status determining unit 207 acquires conversation situational data output by the conversation situation analyzing unit 204. By performing the following processes based on the conversation situational data, the group status determining unit 207 analyzes a group status including a group type, a role of each member (relationship), and a status change of the group.

In step S1002, the group status determining unit 207 determines connections among speakers in a conversation. Conversation situational data includes a speaker of each utterance, a connection among utterances, and intentions (proposal, agreement, disagreement, and the like) of the utterances. Therefore, based on conversation situational data, a frequency of conversation between a pair of speakers (for example, “speaker A and speaker B are frequently engaged in direct conversation” or “there is no direct communication between speaker A and speaker B”) and how often utterances of proposals, agreements, and disagreements are made between a pair of speakers (for example, “speaker A has voiced X number of proposals, Y number of agreements, and Z number of disagreements with respect to speaker B”) can be comprehended. The group status determining unit 207 obtains the information described above for each pair of speakers in the group.

In step S1003, the group status determining unit 207 determines an opinion exchange situation among the members. An opinion exchange situation includes information such as liveliness of exchange of opinions in the group, a ratio of agreements against disagreements with respect to a proposal, and presence or absence of an influencer in decision making. The liveliness of exchange of opinions can be assessed based on, for example, the number of utterances or the number of agreements or disagreements between when a proposal is made and when a final decision is made. In addition, the presence or absence of an influencer in decision making can be assessed based on, for example, whether or not there is only a small number of disagreements with respect to a proposal made by a specific speaker and only consent or agreements occur or whether or not a proposal or an opinion of a specific speaker is adopted at a high rate as a final opinion. Since conversation situational data includes a speaker of each utterance, a connection among utterances, utterance intentions, contents of the utterances, and the like, the group status determining unit 207 can determine the opinion exchange situation described above based on the conversation situational data.

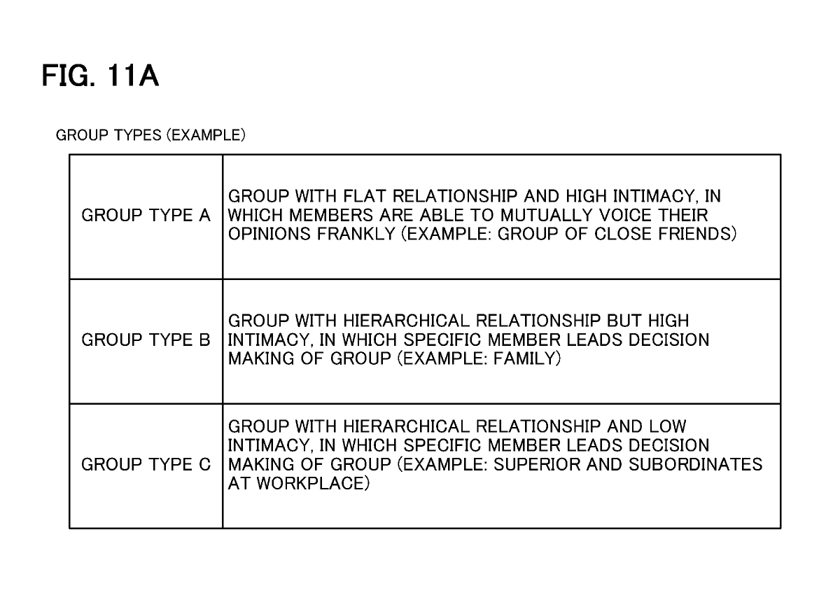

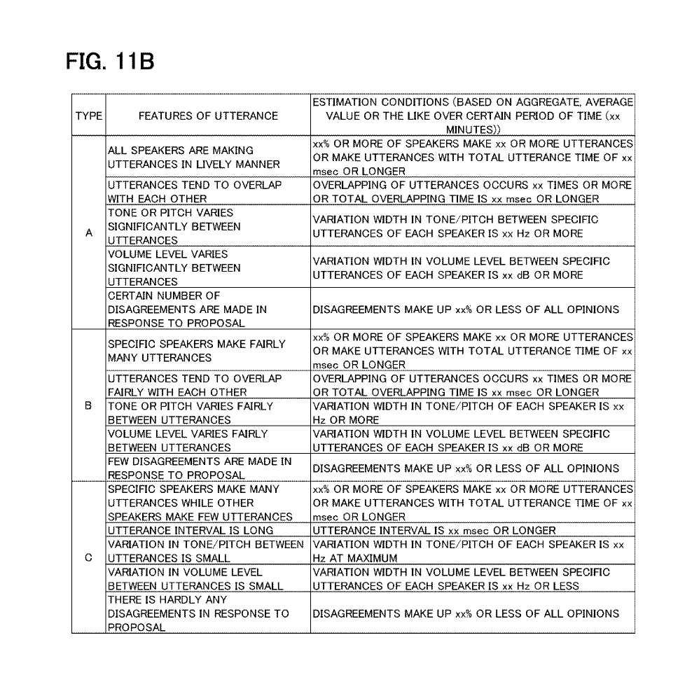

In step S1004, the group status determining unit 207 estimates a group type (a group model) based on utterance feature values and wording of the utterance contents included in the conversation situational data, the connection among speakers obtained in step S1002, and the opinion exchange situation among speakers obtained in step S1003. Group types are defined in advance and, as shown in FIG. 11A, conceivable examples thereof include group type A: “a group with a flat relationship and high intimacy, in which members are able to mutually voice their opinions frankly”, group type B: “a group with a hierarchical relationship but high intimacy, in which a specific member leads decision making of the group”, and group type C: “a group with a hierarchical relationship and low intimacy, in which a specific member leads decision making of the group”. Group type A assumes a group in which all of the members are connected in a flat manner such as a group of close friends. With group type A, there may be cases where an influencer (a member who is particularly influential in decision making) is present and cases where an influencer is not present. Group type B assumes a group which has a strong connection between the members and which has a hierarchical relationship such as a family. an influencer (for example, a parent) is present in group type B. Group type C assumes a group which has a relatively “dry” relationship and which has a hierarchical relationship such as a superior and subordinates at a workplace. Group type C has an influencer (a highest ranking member). While only three group types have been described as examples, there may be any number of group types.

Determination criteria for each group type are stored in the group model definition storage unit 208. The group model definition storage unit 208 stores a plurality of determination criteria based on utterance feature values, wording of utterance contents, a connection among speakers, opinion exchange information, and the like. FIG. 11B shows an example of determination criteria based on utterance feature values. Since group type A represents “a group with a flat relationship and high intimacy, in which members are able to mutually voice their opinions frankly”, group type A often includes characteristics such as “all speakers are making utterances in a lively manner”, “utterances tend to overlap with each other”, “the tone or pitch in each utterance varies significantly”, “power level of voice varies significantly”, and “a certain number of disagreements are made in response to a proposal”. In consideration thereof, as determination criteria of group type A based on utterance feature values, the group model definition storage unit 208 includes determination criteria of, for example, “60% or more of all speakers make three or more utterances in three minutes or make utterances with a total utterance time of 20 seconds or longer”, “overlapping of utterances occurs three times or more in three minutes or a total overlapping time is five seconds or longer”, and “a variation width in the tone, the pitch, or the sound pressure level of each speaker is equal to or greater than a prescribed threshold”. The group status determining unit 207 assesses to what degree the current group satisfies these determination criteria and obtains an assessment value representing a likelihood of the current group being group type A. Assessment values are similarly obtained for the other group types B and C.

Although the group status determining unit 207 may determine a group type only using the assessment value obtained above or, in other words, may determine a group type based solely on utterance feature values, the group status determining unit 207 determines a group type by also taking other elements into consideration in order to further improve determine accuracy.

For example, the group status determining unit 207 analyzes utterance contents (texts) in a conversation to acquire a frequency of appearance of commanding language, honorifics, polite language, deferential language, informal language (language used in intimate relationships), language used by children, language used for children, and the like in utterances of each speaker. Accordingly, the wording of each speaker in the conversation can be revealed. The group status determining unit 207 estimates the group type by also taking wording into consideration. For example, when “there is a person using commanding language and a person responding thereto in honorifics, polite language, or deferential language in the group”, a determination can be made that the group type is likely to be group type C. In addition, when “a group includes a person using commanding language but also a person responding in informal language thereto”, a determination can be made that the group type is likely to be group type A. Furthermore, when “most speakers in a group use a lot of informal language”, a determination can be made that the group type is likely to be group type A or B. Moreover, when “a group includes a person using wording that is typically used by a parent (adult) to address a child and a person using wording that is typically used by a child”, a determination can be made that the group type is likely to be group type B. The cases described above are merely examples, and as long as correlations between group types and wording are defined in advance, the group status determining unit 207 can determine which group type the current group is most likely to correspond to.

In addition, the group status determining unit 207 can also determine a group type based on an opinion exchange situation in a conversation. For example, when a lively exchange of opinions is taking place in a group or when a relatively large number of rejections or disagreements are being made with respect to a proposal, a determination can be made that the group type is likely to be group type A or B. In addition, when the exchange of opinions in a group is not lively or when an influencer is present in the group, a determination can be made that the group type is likely to be group type C. The cases described above are merely examples, and as long as correlations between group types and opinion exchange situations are defined in advance, the group status determining unit 207 can determine which group type the current group is most likely to correspond to.

The group status determining unit 207 integrates group types estimated based on utterance feature values, wording, opinion exchange situations, and a connection among speakers as described above and determines a group type which best matches the current group as a group type of the current group.

In step S1005, the group status determining unit 207 estimates a role of each member in the group using the results of analyses performed in steps S1002 and S1003 and other conversation situational data. Examples of roles in a group include an influencer in decision making and a follower with respect to the influencer. In addition, a superior, a subordinate, a parent, a child, and the like may also be estimated as roles. When estimating a role of a member, favorably, the group type determined in step S1004 is also taken into consideration.

In step S1006, the group status determining unit 207 estimates a status change of a group. A group status includes utterance frequencies, participants in a conversation, specification of an influencer of the conversation, and the like. Examples of the status change estimated in step S1006 include a decline in utterance frequency of a specific speaker, a decline in overall utterance frequency, separation of a conversation group, and a change of influencers.

In step S1007, the group status determining unit 207 consolidates the group type estimated in step S1004, the roles of the respective members estimated in step S1005, and the status change of the group estimated in step S1006 to create group status data, and outputs the group status data to the intervening/arbitrating unit 209. By referring to the group status data, the intervening/arbitrating unit 209 can comprehend what kind of status a group currently engaged in a conversation is in and can perform an appropriate intervention in accordance with the status.

<Intervening/Arbitrating Process>

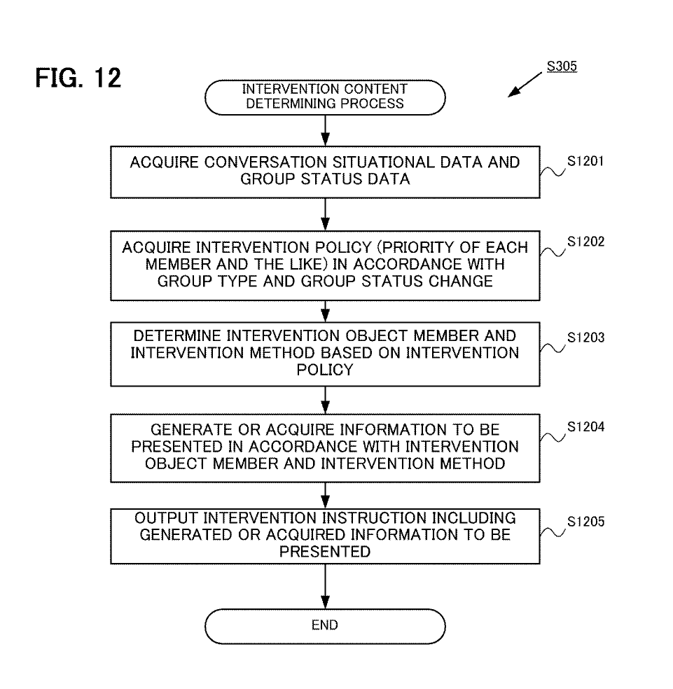

Next, details of the intervention content determining process in step S305 in FIG. 3 will be described. FIG. 12 is a flow chart showing a flow of the intervention content determining process.

In step S1201, the intervening/arbitrating unit 209 acquires the conversation situational data output by the conversation situation analyzing unit 204 and the group status data output by the group status determining unit 207. By performing the following processes based on these pieces of data, the intervening/arbitrating unit 209 determines contents of information to be presented when performing an intervention or arbitration.

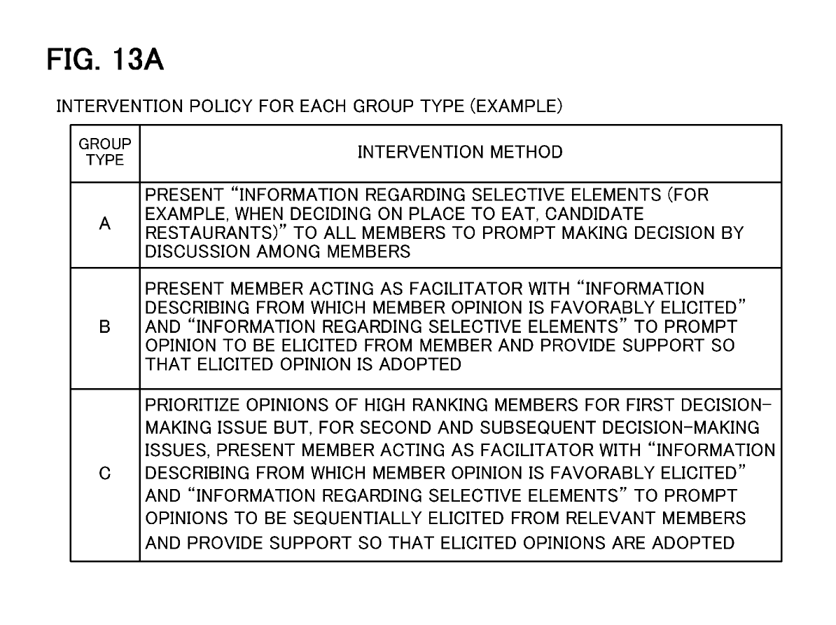

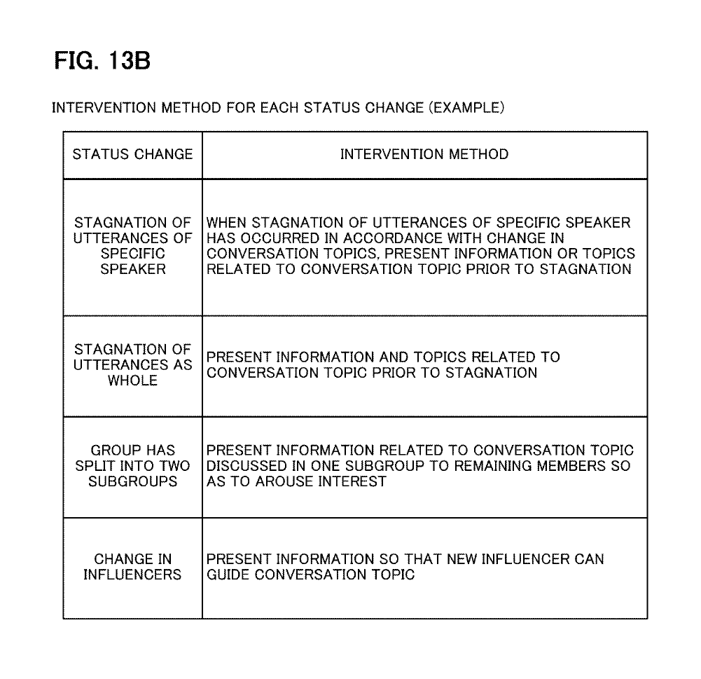

In step S1202, the intervening/arbitrating unit 209 acquires an intervention policy in accordance with the group type or the group status change included in the group status data from the intervention policy definition storage unit 210. An intervention policy refers to information indicating which member in the group is to be preferentially supported and in what way in accordance with the group status. Examples of intervention policies defined in the intervention policy definition storage unit 210 are shown in FIGS. 13A and 13B.

FIG. 13A shows examples of intervention policies in accordance with group types. For example, as an example of an intervention policy with respect to group type A which represents “a group with a flat relationship and high intimacy, in which members are able to mutually voice their opinions frankly”, a policy of “presenting information regarding selective elements (for example, when deciding on a place to eat, candidate restaurants) to all members” is defined in order to prompt decision making by discussion among the members. In addition, as an example of an intervention policy with respect to group type B which represents “a group with a hierarchical relationship but high intimacy, in which a specific member leads decision making of the group”, a policy of “presenting a member acting as a facilitator with information describing from which member an opinion is favorably elicited and information regarding selective elements and providing support so that an opinion is elicited from the member and that the opinion is adopted” is defined in order to prompt an opinion to be elicited from a member in a vulnerable position who is unable to express an opinion and to have the elicited opinion adopted. Furthermore, as an example of an intervention policy with respect to group type C which represents “a group with a hierarchical relationship and low intimacy, in which a specific member leads decision making of the group”, a policy of “prioritizing opinions of high ranking members for a first decision-making issue but, for second and subsequent decision-making issues, presenting a member acting as a facilitator with information describing from which member an opinion is favorably elicited and information regarding selective elements and providing support so that opinions are sequentially elicited from relevant members and that the opinions are adopted” is defined in order to provide support so as to prevent only the opinions of specific members from being adopted. Moreover, the member acting as a facilitator in these policies refers to a person who is particularly capable of being sensitive to members in vulnerable positions who are unable to express their opinions and supporting such members so as to elicit and adopt their opinions. In addition, while FIG. 13A shows one intervention policy being defined for each group type, a plurality of intervention policies may be defined for each group type.

FIG. 13B shows examples of intervention policies in accordance with status changes of groups. For example, when stagnation of utterances (a decline in utterance frequency) of a specific speaker has occurred and the stagnation has occurred in accordance with a change in conversation topics, information related to a conversation topic prior to the stagnation is presented. In addition, when stagnation of utterances as a whole has occurred, information related to the conversation topic prior to the stagnation is presented. Furthermore, when the group has split into two subgroups and each subgroup is engaged in a different conversation, information related to a conversation topic of one subgroup is presented to members of the other subgroup so as to arouse interest. Moreover, when there is a change in influencers, information is provided so that the new influencer can guide the conversation topic. In addition, while FIG. 13B shows one intervention policy being defined for each status change of a group, a plurality of intervention policies maybe defined for each status change.

The intervention policies described above may be considered information defining a priority of an intervention and what kind of intervention is to be performed with respect to each member in a group in accordance with a group type and a status change of the group. Instead of being set with respect to individual members, a priority of intervention is set with respect to a member performing a role (such as an influencer) in a group or a member satisfying specific conditions (a decline in utterance frequency). However, all intervention policies need not necessarily include an intervention priority.

In step S1203, the intervening/arbitrating unit 209 determines an intervention object member and an intervention method based on the intervention policy acquired in step S1202. For example, the intervening/arbitrating unit 209 makes a determination to provide an influencer with information accommodating preferences of other members or to provide information related to a conversation topic that is preferred by a speaker whose utterances have stagnated. Moreover, a determination to not perform an intervention at this time may be made in step S1203. The determination in step S1203 need not necessarily be made solely based on an intervention policy and is also favorably made based on other information such as conversation situational data. For example, when it is determined based on the utterance intentions included in conversation situational data that an exchange of opinions for decision making is being performed in a group, an intervention object and an intervention method may be determined based on an intervention policy for supporting decision making.

In step S1204, the intervening/arbitrating unit 209 generates or acquires information to be presented in accordance with the intervention object member and the intervention method. For example, when providing an influencer with information accommodating preferences of other members, first, the preferences of other members are determined by acquiring the preferences based on previously-discussed conversation themes and emotions (levels of excitement or the like) of the members or acquiring the preferences from the database 123 of user information and usage history. In a case where a member prefers Italian cuisine when a conversation about a place for lunch is being carried out, information regarding Italian restaurants is acquired from the related information website 130 or the like. In doing so, favorably, the restaurants to be presented are narrowed down by also taking into consideration positional information acquired from the GPS device 112 of the vehicle 110.

In step S1205, the intervening/arbitrating unit 209 generates intervention instruction data including the information to be presented generated or acquired in step S1204 and outputs the intervention instruction data. In the present embodiment, the intervention instruction data is transmitted from the server device 120 to the navigation device 111 of the vehicle 110. Based on the intervention instruction data, the output control unit 212 of the navigation device 111 generates synthesized speech or a text to be displayed and presents the information through the speaker 213 or the display 214 (S306).

The series of conversation intervention supporting process (FIG. 3) described above is repetitively executed. Favorably, a short repetition interval is adopted so that interventions can be performed at appropriate timings with respect to utterances. However, all of the processes need not necessarily be performed every time the repetitive process is performed. For example, conversation situation analysis S303 and group status determination S304 may be performed at certain intervals (for example, three minutes). In addition, even when determining a group status, a determination of a group type and a determination of a status change of a group may be performed at different execution intervals.

### Advantageous Effects of the Present Embodiment

In the present embodiment, the conversation situation analyzing unit 204 is capable of specifying a group of utterances including a same conversation theme in a conversation held by a plurality of speakers and further comprehending whether or not a relationship exists between respective utterances and, if so, what kind of relationship. Furthermore, a situation of the conversation can be estimated based on intervals and degrees of overlapping of utterances among the speakers with respect to a same conversation. With the conversation situation analysis method according to the present embodiment, even when a large number of speakers are split into different groups and are simultaneously engaged in conversations, a situation of each conversation can be comprehended.

In addition, in the present embodiment, the group status determining unit 207 is capable of comprehending a type or a status change of a group engaged in a conversation or a role of each speaker and a relationship among the respective speakers in the group based on conversation situational data and the like. The ability to comprehend such information enables a determination to be made as to which speaker is to be preferentially supported when the system intervenes in a conversation and enables an appropriate intervention to be performed in accordance with the status of the group. <Modifications>

While an example of a conversation intervention support system being configured as a telematics service in which a vehicle and a server device cooperate with each other has been described above, a specific mode of the system is not limited thereto. For example, the system can be configured so as to acquire a conversation taking place indoors such as in a conference room and to intervene in the conversation.

### EXAMPLES

The present invention can be implemented by a combination of software and hardware. For example, the present invention can be implemented as an information processing device (a computer) including a processor such as a central processing unit (CPU) or a micro processing unit (MPU) and a non-transitory memory that stores a computer program, in which case the functions described above are provided as the processor executes the computer program. Alternatively, the present invention can be implemented with a logic circuit such as an application specific integrated circuit (ASIC) or a field programmable gate array (FPGA). Further alternatively, the present invention can be implemented using both a combination of software and hardware and a logic circuit. In the present disclosure, a processor configured so as to realize a specific function and a processor configured so as to function as a specific module refer to both a CPU or an MPU which executes a program for providing the specific function or a function of the specific module and an ASIC or an FPGA which provides the specific function or a function of the specific module.

What is claimed is:

1. A group status determining device determining a status of a group made up of a plurality of speakers engaged in a conversation, the group status determining device comprising:
a storage that stores determination criteria, based on conversation situational data with respect to a plurality of group types; and
a processor configured to operate as:
an acquisition module that acquires conversation situational data, which is data regarding a series of groups of utterances made by a plurality of speakers and estimated to be on a same conversation theme; and
a determination module that acquires a type of the group made up of the plurality of speakers, on the basis of the conversation situational data and the determination criteria as a group status of the group made up of the plurality of speakers.

2. The group status determining device according to claim 1,
wherein the conversation situational data includes an utterance feature value,
wherein the determination criteria are determination criteria of a group type based on the utterance feature value, and
wherein the determination module determines the type of the group, on the basis of the utterance feature value included in the conversation situational data and of the determination criteria.

3. The group status determining device according to claim 2,
wherein the conversation situational data includes utterance intentions and a relationship among utterances, and
wherein the determination module estimates an opinion exchange situation in the group in consideration of the utterance intentions and the relationship among utterances included in the conversation situational data and determines the type of the group also in consideration of the opinion exchange situation.

4. The group status determining device according to claim 3, wherein the determination module determines at least any of liveliness of exchange of opinions in the group, a ratio of agreements against disagreements with respect to a proposal, and presence or absence of an influencer in decision making, as the opinion exchange situation.

5. The group status determining device according to claim 3, wherein the determination module further determines a relationship among a plurality of speakers included in the group, on the basis of the utterance intentions and the relationship among utterances, as a group status.

6. The group status determining device according to claim 5, wherein the determination module estimates a superior or an influencer in decision making in the group as the relationship among the plurality of speakers included in the group.

7. The group status determining device according to claim 2, wherein the determination module determines the type of the group also in consideration of wording in utterances.

8. The group status determining device according to claim 7, wherein the determination module further determines a relationship among a plurality of speakers included in the group, on the basis of wording of utterances, as a group status.

9. The group status determining device according to claim 8, wherein the determination module estimates a superior or an influencer in decision making in the group as the relationship among the plurality of speakers included in the group.

10. The group status determining device according to claim 2, wherein the determination module determines whether or not stagnation in utterances has occurred, on the basis of the utterance feature value, as a group status.

11. A support device providing support by intervening in a conversation held by a group made up of a plurality of speakers, the support device comprising the group status determining device according to claim 1, wherein the processor is further configured to operate as an intervention module that determines contents of an intervention in the conversation held by the group, on the basis of an intervention policy corresponding to an acquired group status, and that intervenes in the conversation using the determined intervention contents.

12. The support device according to claim 11,
wherein the group status includes a type of a group and a relationship among members of the group, and
wherein the intervention policies define which member in the group is to be preferentially supported for each group type.

13. A computer-implemented method of determining a status of a group made up of a plurality of speakers engaged in a conversation, the method comprising:
an acquiring step of acquiring conversation situational data, which is data regarding a series of groups of utterances made by a plurality of speakers and estimated to be on a same conversation theme; and
a determining step of acquiring a type of the group made up of the plurality of speakers, on the basis of the conversation situational data and determination criteria based on the conversation situational data with respect to a plurality of group types stored in a storage, as a group status of the group made up of the plurality of speakers.

14. A non-transitory computer-readable medium storing a computer program for causing a computer to execute the steps of the method according to claim 13.
